(19) United States
(12) Patent Application Publication
(10) Pub. No.: US 2001/0043662 A1
(43) Pub. Date: Nov. 22, 2001

(54) Flexible source wire for radiation

(76) Inventor: Samuel F. Liprie, Lake Charles, LA (US)

Correspondence Address: CANTOR COLBURN, LLP, 55 GRIFFIN ROAD SOUTH, BLOOMFIELD, CT, 06002

(21) Appl. No.: 09/681,302

(22) Filed: Mar. 15, 2001

Related U.S. Application Data
(63) Continuation of application No. 08/455,579, filed on May 31, 1995, now Pat. No. 5,660,703.
Application No. 08/455,579 is a division of application No. 08/827,787, filed on Apr. 11, 1997.
Application No. 08/827,787 is a division of application No. 08/480,307, filed on Jun. 7, 1995, now Pat. No. 5,857,956.
(63) Continuation-in-part of application No. 08/257,045, filed on Jun. 8, 1994, now Pat. No. 5,503,614.

(51) Int. Cl. G21G 1/06

(52) U.S. Cl. 376/158

(57) ABSTRACT

A flexible source wire is provided containing a radioactive source that is capable of maneuvering through a tortuous narrow passage to a treatment site within the body. This source wire includes a thin flexible housing tube, housing therein a flexible backbone wire, both the tube and the wire being constructed from a material exhibiting little or no memory retention when bent. A radioactive source is provided in the proximal end of the thin flexible housing tube. This radioactive source is contained in a capsule abutting the proximal end of the backbone wire all within a thin wall encapsulating material. Both ends of the source wire are welded shut to form a tight seal and rounded to allow ease of movement as it travels through the bends and turns in the body. The housing tube is coated before the loading of the radioactive material with a non-oxidizing agent such as gold.

### CROSS REFERENCE TO RELATED APPLICATIONS

The present application is a continuation of co-pending application Ser. No. 091, filed on, which is a divisional application of co-pending application Ser. No. 08/827,787, filed on Apr. 11, 1997, which is a divisional of U.S. patent application Ser. No. 08/480,307, filed on Jun. 7, 1995, which is a continuation-in-part of U.S. patent application Ser. No. 08/257,045, filed Jun. 8, 1994, the entire disclosures of which are specifically incorporated by reference herein.

### BACKGROUND OF INVENTION

1. Field of the Invention

The present invention relates to the use of radioactive sources to treat diseases of the body. More particularly, the present invention relates to the use of a flexible member housing a radioactive source for the temporary delivery of radiation to treat diseases of the body.

2. Description of the Prior Art

Radiation is used to treat cancer and other diseases of the body. Radiation has long been proven to destroy fast multiplying cells (e.g., cancer) in hopes of destroying or preventing the spread of the disease. Brachytherapy, which is the treatment of cancer at close distances, is one example of the use of radiation for treating diseases of the body. During brachytherapy, a radioactive source or sources are positioned in the area needing treatment. Depending on the shape, size and delivery means of the radioactive sources, the sources are either kept permanently in the body or removed after a specific amount of time. Since permanent implants are tiny seeds approximately 3 mm long and 0.5 mm wide, the use of these seeds do not relate to the present invention. Consequently, the focus of this application will be on the field of temporary implants.

The term temporary implants describes the procedure of maneuvering a radioactive source or sources to the treatment site utilizing a transport catheter or tube which has been previously placed in the vicinity of this treatment site. Alternatively, the transport catheter and temporary implant can simultaneously be maneuvered to the treatment site. In either situation, after a specified period of time, these sources and the transport catheter or tube are removed from the body. Since the radioactive source or sources may encounter a tortuous path in various arteries, veins, ducts, or the like inside the body to reach the treatment site, the radioactive source is usually attached by some device to a flexible drive member. This source and the drive member may be used many times, and, therefore must be able to withstand the many bends it encounters when it is maneuvered to the treatment site or removed therefrom, without breaking.

There are several devices on the market in which radioactive sources are attached to flexible drive members. Each of these devices is constructed in a different fashion and each has its limitations. Examples of these prior art devices are described in U.S. Pat. Nos. 4,819,618 and 5,141,486, both issued to Liprie as well as U.S. Pat. No. 4,861,520 issued to van″t Hooft. The two Liprie patents describe a radioactive element which is attached to a drive member by means of a junction welded to the drive cable. The patent to van″t Hooft describes an apparatus which attached radioactive sources to a drive cable by means of a stiff capsule welded into the end of the cable. Since the most resistive portion to flection of any flexible material, such as a cable, tube, or wire is the segment closest to the end, to join a capsule which is stiffer than this material and welded onto its end would only add to the resistance to bending and would adversely effect maneuvering the material through the body.

U.S. Pat. No. 5,084,002 issued to Liprie describes an ultra-thin high dose iridium source included within an oversized hole drilled inside the end of a solid platinum wire. The whole assembly is then drawn down to the desired diameter of the wire. While this patent does not describe the situation in which a radioactive source is joined to the end of a solid cable, the platinum delivery wire would still present problems with respect to maneuvering the wire through the numeral twists and turns in the body.

Finally, U.S. Pat. No. 5,282,781 issued to Liprie employs a tube, a backbone wire, a pure iridium core and a plug and draws down the entire assembly to form a tight seal between the housing material and the backbone wire and the plug.

Without this drawing down of the housing onto the backbone wire, radioactive flakes from the core would migrate throughout the inside of the assembly wire, resulting in unwanted contamination. This “drawing down” step would increase the costs and difficulty of manufacturing the source wire.

### SUMMARY OF INVENTION

These and other deficiencies of the prior art are addressed by the present invention which is directed to a flexible source wire for the radiation treatment of disease in which the source wire contains a radioactive source and is maneuvered to the site of treatment through various conduits in the body. The flexible source wire includes a flexible housing in the form of an elongated hollow tube constructed from a material such a Nitinol® or a titanium/nickel alloy which exhibits little or no memory retention when it is bent. An internal flexible backbone wire also constructed from the same material as the flexible tube which exhibits little or no memory retention. The backbone wire is provided within the flexible tube.

A thin-walled capsule or encapsulated radioactive core as well as a plug is also provided within the flexible tube. The backbone wire is welded to the distal end of the tube and runs throughout the length of the flexible tube to a distance just short of the proximal end of the tube. The radioactive capsule or encapsulated radioactive core which is provided in the proximal portion of the flexible tube, abuts the end of the backbone wire. The encapsulating material must have a very thin wall to allow flexibility. This thin wall should be constructed from material that will block very little of the neutron flux as the core is being irradiated, as well as not becoming radioactive or exhibit an insignificant amount of radioactivity after a period of approximately 20 days. A good example of this material is titanium, platinum, gold or high purity aluminum such as aluminum 1100.

A plug is provided at the proximal and of the tube to seal the radioactive capsule or the encapsulated radioactive core within the tube. Mounting the radioactive source into the segment of a tube which is naturally stiff would not add any appreciable resistance to bending, in contradistinction to the Liprie “618 and Liprie” 487 patents, as well as the patent to van″t Hooft. Since material such as Nitinol® as well as a titanium/nickel alloy which exhibits little or no memory retention when bent have dissimiliar welding properties than other metals, they do not form a strong bond against the stress of repeated bending. This feature would reduce the possibility that the device is prone to breakage.

Furthermore, due to the characteristics of “little or no memory” material such as Nitinol®, a titanium/nickel alloy etc., the “drawing down” of the material illustrated in Liprie ″781 is not possible. Furthermore, providing a source wire as illustrated in Liprie ″002 in which an iridium source is inserted into a hole which is drilled into the end of a thin wire is not necessary. Drilling a hole into a thin wire is very difficult since the maximum depth the hole can be drilled is equal to approximately seven times the outside diameter of the wire. To drill a hole deeper than this distance is extremely difficult due to the drifting of the drill as it burrows the hole. This drifting can lead to a thinning of the cavity walls which greatly increases the chance of breakage. This breakage is often disastrous, resulting in unwarranted radiation exposure. A larger outside diameter wire will be needed to compensate for the drifting and still allow the walls of the cavity to be thick enough to withstand stress. Unfortunately, this larger diameter wire might be too large to fit into many constricted areas of the body. Additionally, this larger diameter wire would result in less flexibility and may not be able to be maneuvered to the treatment site. Another method of drilling the cavity inside a solid wire, would be to start with an oversize wire and an oversize hole and draw the entire structure down to size. Whenever a wire is drawn down, the assembly containing the cavity elongates and precise positioning of the radioactive core inside the assembly can become very difficult. Utilizing a tube as the flexible source as is utilized in the present invention would eliminate the need for this type of drilling.

### BRIEF DESCRIPTION OF DRAWINGS

These and other attributes of the present invention will be described with respect to the following drawings in which:

FIG. 1 is a partial cross-section of the invention showing a radioactive core inside a thin wall capsule provided within the flexible source tube;

FIG. 2. is a partial cross-section of the present invention showing the use of the encapsulated core within the flexible source tube; and

FIG. 3 is a partial cross-section of the present invention provided with a proximal end having a funnel shape.

### DETAILED DESCRIPTION

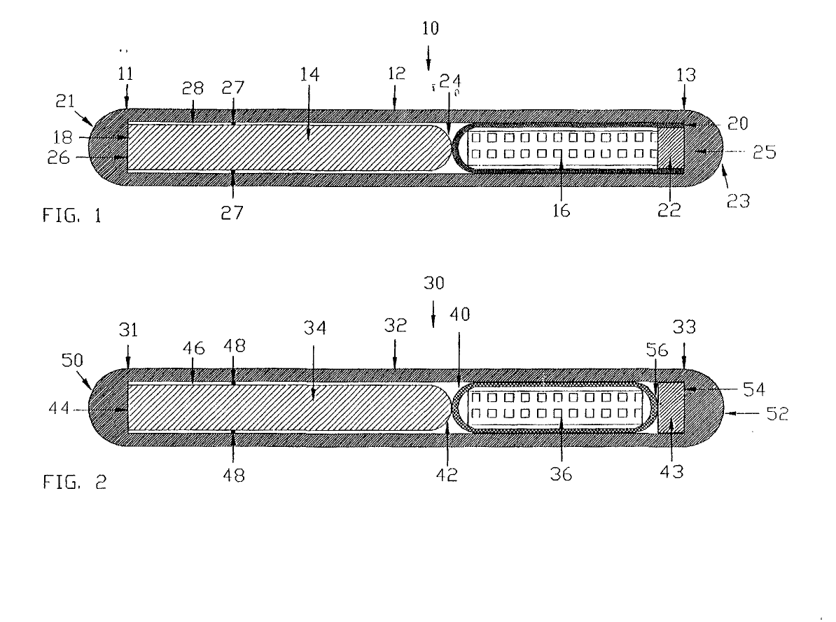

FIG. 1 illustrates a first embodiment of the present invention 10 utilizing a radioactive core 16 provided within a thin-walled capsule. This embodiment employs an elongated hollow housing tube 12 constructed from a material such a Nitinol®, a titanium/nickel alloy or similar materials which exhibit little or no memory retention when the tube is bent. Since this housing tube is used to maneuver the radioactive core to a remote treatment site, the length of the tube is generally greater than 100 cm and, could extend for a much greater distance. Additionally, since the housing tube must be maneuvered within various twists and turns in the body through various conduits therein, the diameter of this tube could range from 0.018″ to 0.023″.

A flexible backbone wire 14 is provided between the distal end 11 of housing tube 12 and extends to several millimeters from the end of the proximal portion 13 of the housing tube. For ease of initially inserting the backbone wire 14 into the tube 12 and to allow greater pivoting of the assembly while reducing stress to the housing material, the end 24 of this wire is rounded. Similar to the housing tube 12, this backbone wire 14 can also be constructed from material such as Nitinol®, a titanium/nickel alloy or other materials which exhibit little or no memory retention when bent.

A capsule 20 is inserted into the proximal end of the housing tube 12 until it abuts the rounded end 24 of the backbone wire 14. The capsule should be manufactured from a very thin-walled metallic material. The radioactive core 16 is then inserted within the capsule and a plug 22 abutting the proximal end of the core 16 is provided within the capsule 20 and is used to seal the radioactive core 16 in place.

The plug 22 is sealed in place using a weld 25 or other methods of forming a tight seal. The distal end of the backbone wire 18 is welded in place at 26. Both ends 21, 23 of the housing tube 12 are rounded to allow ease of movement as it travels through bends and turns in the body. The exterior of the housing tube 12 is coated prior to the loading of the radioactive core 16 with a non-oxidizing agent, such as gold. The backbone wire 14 can be welded, fused or glued to different areas of the inner tube, such as 27 to serve as an internal safety and protection device. If the outer tube 12 breaks, the radioactive source 16 would still be able to be retracted. For ease of inserting the backbone wire 14 into the interior of the tube 12, a small gap 28 between the inner surface of the tube and the outer surface of the wire is provided. The outside diameter of the capsule 20 should fit snugly against the inside diameter of the tube 12. However, it is noted that a small gap can also be included between the capsule 20 and the interior wall of the tube 12.

FIG. 2 illustrates a second embodiment 30 of the present invention utilizing an elongated cylindrical housing tube 32 similar in dimension to the tube described with respect to FIG. 1. This tube is constructed from material such as Nitinol®, a titanium/nickel alloy or a similar material which exhibits little or no memory retention when bent. A backbone wire 34 constructed from the same material as the housing tube 32 is introduced to the interior of the housing tube 32 and extends from the distal end 31 thereof to an area positioned several millimeters from the proximal end 33 of the tube. The backbone wire 34 is provided with rounded end 42 to aid in movement within the tube 32. A source of radioactivity 36 is provided within a thin wall encapsulating material 40 so that it abuts the rounded end 42 of the backbone wire 34. This thin material 40 should allow the passage of neutrons to irradiate the inner core but the same time this material should obtain no significant radioactivity. The radioactive treatment to be delivered must come from the radiation exposure of the inner core 36 and not from the radiation exposure of the encapsulation material 40. The encapsulation material should be flexible. A good example of this material would be platinum, gold, titanium, or high purity aluminum such as aluminum 1100.

The backbone wire 34 is introduced into the distal end of the housing tube 32 and is welded in place by weld 44. Additionally, the backbone wire 34 can be affixed to various inner surfaces of the housing tube 32 such as at spot 48 by welding, fusing, pasting or other methods. A small gap 46 is provided between the outer surface of the backbone wire 34 and the inner surface of the housing tube 32. This gap aids in allowing the backbone wire 34 to be moved to its proper position within the housing tube 32. The encapsulated core is introduced into the interior of the housing tube 32 at its proximal end so that it abuts the rounded edge 42 of the backbone wire 34. A plug 43 is then loaded into the proximal end of the housing tube 32 so that it abuts the rounded proximal end 56 of the encapsulated core. The plug is then welded in place by weld 54. Both the proximal and distal ends of the housing tube 32 are rounded at 50, 52 to aid in the maneuverability of the housing tube 32 within the body. Furthermore, similar to the embodiment illustrated in FIG. 1, the outer surface of the housing tube 32 is coated with a non-oxidizing agent such as gold.

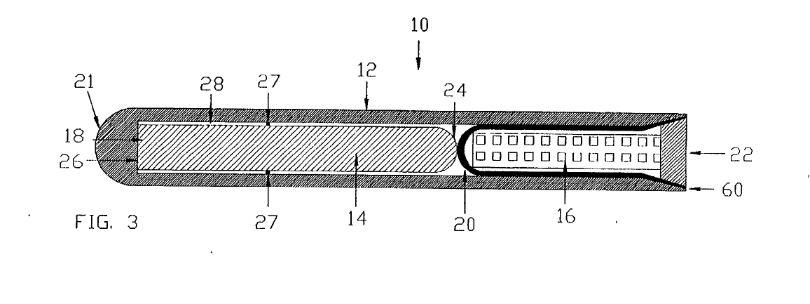

FIG. 3 illustrates a flexible source wire similar in many respects to the embodiments shown in FIGS. 1 and 2. In this embodiment, similar elements in FIG. 1 will have the same reference numerals as their respective elements in FIG. 3. Furthermore, although the embodiment shown in FIG. 3 illustrates a flexible source wire utilizing a radioactive core within a capsule, these teachings can also be applied to the situation in which the radioactive core is encapsulated.

After the backbone wire 14 is inserted through the distal end of the housing tube 12 and properly affixed in place, the capsule 20 is introduced into the proximal end of the housing tube 12 by utilizing a stylet. The inner portion of the wall of the housing tube 12 exhibits a slightly tapered funnel shape 60 or is countersunk at the proximal end of the tube to aid in the introduction of the capsule. Similarly, the encapsulated radioactive core shown in FIG. 2 can be introduced into a tube having a slight funnel shape at its proximal end. Once the capsule is in place, the radioactive core 16 is introduced therein manually utilizing a tweezers or automatically employing a similar device in a robot handling system. Once the capsule 20 and the radioactive core 16 or the encapsulated core 36 is introduced into the proximal end of its respective tube until it abuts the proximal end of its respective backbone wire, a plug is loaded in place and then sealed.

Having described several embodiments of the new and improved flexible source wire for radiation treatment in accordance with the present invention, it is believed that other modifications, variations, and changes will be suggested to those skilled in the art in view of the description set forth above. It is therefore to be understood that all such variations, modifications and changes are believed to fall within the scope of the invention as defined in the appended claims.

1. A flexible source wire for radiation treatment of diseases within a body comprising:
a flexible, hollow, elongated housing tube having a distal end and a proximal end, said housing tube constructed from a material exhibiting little or no memory retention when bent;
a flexible backbone wire having a proximal end, said proximal end of said wire being disposed in said housing tube, and further wherein the proximal end of said backbone wire is rounded; and
a radiation source or sources provided within said housing tube, said proximal end of said flexible backbone wire being adjacent to said radiation source or sources.

2. The flexible source wire in accordance with claim 1 further including a plug which is sealed to said proximal end of said housing tube.

3. The flexible source wire of claim 1, wherein said radioactive source is encapsulated within a neutron permeable material.

4. The flexible source wire of claim 1, wherein said radioactive source is included within a thin walled-capsule.

5. The flexible source wire in accordance with claim 1 wherein said housing tube is constructed from a material such as Nitinol or a titanium/nickel alloy.

6. The flexible source wire in accordance with claim 2 wherein said housing tube is constructed from a material such as Nitinol or a titanium/nickel alloy.

7. The flexible source wire in accordance with claim 3 wherein said housing tube is constructed from a material such as Nitinol or a titanium/nickel alloy.

8. The flexible source wire in accordance with claim 1 wherein a portion of the inner surface of said proximal end of said housing tube exhibits a tapered funnel shape for ease of loading said radioactive source or sources within said flexible housing tube.

9. The flexible source wire in accordance with claim 1, wherein said backbone wire is completely disposed in said housing tube.

10. The flexible source wire in accordance with claim 1 wherein said backbone wire is affixed to the interior wall of said flexible housing tube at one or more locations.

11. The flexible source wire in accordance with claim 1, wherein said backbone wire includes a distal end, and wherein said distal end is disposed within said tube.

12. The flexible source wire in accordance with claim 1 wherein the outer surface of said housing tube is coated with a non-oxidizing agent.

13. The flexible source wire in accordance with claim 12 wherein said non-oxidizing agent is gold.

14. A flexible source wire for radiation treatment of diseases within a body comprising:
a flexible, hollow, elongated housing tube having a distal end and a proximal end, said housing tube constructed from a material exhibiting little or no memory retention when bent;
a flexible backbone wire having a proximal end, said proximal end of said wire inserted into said tube, and further wherein the proximal end of said backbone wire is rounded;
a radiation source or sources provided within said housing tube, said proximal end of said flexible backbone wire being adjacent to said radiation source or sources.

15. The flexible source wire in accordance with claim 14 further including a plug, which is sealed to said proximal end of said housing tube.

16. The flexible source wire in accordance with claim 14 wherein said housing tube is constructed from a material such as Nitinol or a titanium/nickel alloy.

17. The flexible source wire in accordance with claim 14 wherein a portion of the inner surface of said proximal end of said housing tube exhibits a tapered funnel shape for ease of loading said radioactive source or sources within said flexible housing tube.

18. The flexible source wire of claim 14, wherein the radioactive source is included within a thin-walled capsule.

19. The flexible source wire of claim 14, wherein the radioactive source is encapsulated within a neutron permeable material.

20. The flexible source wire in accordance with claim 14, wherein said backbone wire is completely inserted in said housing tube.

21. The flexible source wire of claim 14, wherein the backbone wire includes a distal end, and wherein the backbone wire is completely inserted such that the distal end is disposed within the tube.

22. The flexible source wire in accordance with claim 14, wherein said backbone wire is affixed to the interior wall of said flexible housing tube at one or more locations.

23. The flexible source wire in accordance with claim 14 wherein the outer surface of said housing tube is coated with a non-oxidizing agent.

24. The flexible source wire in accordance with claim 14 wherein said non-oxidizing agent is gold.

25. A flexible source wire for radiation treatment of diseases within a body comprising:
a flexible, hollow, elongated housing tube having a distal end and a proximal end, said housing tube constructed from a material exhibiting little or no memory retention when bent;
a flexible backbone wire having a proximal end, said proximal end of said wire inserted into said tube, and further wherein the proximal end of said backbone wire is rounded;
a capsule inserted into said proximal end of said flexible elongated housing tube;
a radiation source or sources inserted into said capsule; and
a plug which seals said proximal end of said housing tube.

26. The flexible source wire in accordance with claim 25 wherein said housing tube is constructed from a material such as Nitinol or a titanium/nickel alloy.

27. The flexible source wire in accordance with claim 25 wherein a portion of the inner surface of said proximal end of said housing tube exhibits a tapered funnel shape for ease of loading said radioactive source or sources within said flexible housing tube.

28. The flexible source wire in accordance with claim 25, wherein said backbone wire is completely disposed in said housing tube.

29. The flexible source wire of claim 25, wherein the backbone wire includes a distal end, and wherein the backbone wire is completely inserted such that the distal end is disposed within the tube.

30. The flexible source wire in accordance with claim 25 wherein said backbone wire is affixed to the interior wall of said flexible housing tube at one or more locations.

31. The flexible source wire in accordance with claim 25 wherein the outer surface of said housing tube is coated with a non-oxidizing agent.

32. The flexible source wire in accordance with claim 31 wherein said non-oxidizing agent is gold.
